(19) United States
(12) Patent Application Publication
(10) Pub. No.: US 2013/0023131 A1
(43) Pub. Date: Jan. 24, 2013

(54) CONNECTING PART BETWEEN LEAD-IN AND MARINE STREAMER AND METHOD

(71) Applicants: Hervé RICHER DE FORGES, Massy (FR); Denis PENGAM, Taule (FR)

(72) Inventors: Hervé RICHER DE FORGES, Massy (FR); Denis PENGAM, Taule (FR)

(73) Assignee: CGGVERITAS SERVICES SA, Massy Cedex (FR)

(21) Appl. No.: 13/551,935

(22) Filed: Jul. 18, 2012

Related U.S. Application Data
(60) Provisional application No. 61/509,731, filed on Jul. 20, 2011.

(51) Int. Cl. H01R 33/945

(52) U.S. Cl. 439/34

(57) ABSTRACT

Seismic data acquisition system, method, and connecting part configured to connect a lead-in to a streamer. The connecting part includes a single body extending along a longitudinal axis (X) between the lead-in and the streamer; the single body has a first end configured to connect to the lead-in through a first connection device and the body also has a second end configured to connect to the streamer through a second connection device; at least a link connecting the first end to the second end and configured to receive a tension that appears in the single body; a cable extending through the single body and configured to provide data communications; and plural modules provided on the single body. The single body is configured to wound-up on a spool.

### RELATED APPLICATION

The present application is related to, and claims priority from U.S. Provisional Patent Application No. 61/509,731, filed Jul. 20, 2011, entitled “Connecting Part between Lead-In and Marine Streamer and Method” to Hervé Richer de Forges and Denis Pengam, the disclosure of which is incorporated herein by reference.

### BACKGROUND

1. Technical Field

Embodiments of the subject matter disclosed herein generally relate to methods and systems and, more particularly, to mechanisms and techniques for connecting a lead-in to a streamer.

2. Discussion of the Background

Reflection seismology is a method of geophysical exploration to determine the properties of a portion of a subsurface layer in the earth, which information is especially helpful in the oil and gas industry. Marine reflection seismology is based on the use of a controlled source that sends energy waves into the earth. By measuring the time it takes for the reflections to come back to plural receivers, it is possible to estimate the depth and/or composition of the features causing such reflections. These features may be associated with subterranean hydrocarbon deposits.

During a seismic gathering process, as shown in FIG. 1, a vessel 10 tows an array of seismic detectors provided on streamers 12. The streamers may be disposed horizontally, i.e., lying at a constant depth relative to a surface 14 of the ocean. The vessel 10 also tows a seismic source assembly 16 that is configured to generate an acoustic wave 18. The acoustic wave 18 propagates downwards toward the seafloor 20 and penetrates the seafloor until eventually a reflecting structure 22 (reflector) reflects the acoustic wave. The reflected acoustic wave 24 propagates upwardly until the same is detected by detector 26.

The streamers 12 are shown in FIG. 1 spreading over a predetermined area. This is called the seismic spread. In order to maintain the plural streamers 12 substantially parallel and at equal distances from each other, various front-end gears are used. A front-end gear includes a collection of cables, links, ropes etc. that connect the seismic spread to the vessel.

A conventional configuration of a seismic spread and front-end gear is shown in FIG. 2. FIG. 2 shows a vessel 40 connected to wide ropes 42 provided at respective ends with deflectors 44. Plural lead-in cables 46 are connected to streamers 50. The plural lead-in cables 46 also connect to the vessel 40. The streamers 50 are maintained at desired separations from each other by spread ropes 48. Plural sources 52 are also connected to and towed by the vessel 40.

FIG. 3 shows a side view of the lead-in 46 and the streamer 12. A section 60 makes the connection between the lead-in 46 and the streamer 12. A part of the lead-in 46 is suspended via a cable or rope 62 to a corresponding float 64. If the vessel 40 tows, for example, ten streamers, then, for each streamer, there is a corresponding lead-in and a corresponding section 60 as shown in FIG. 3. Section 60, which includes many different modules that connect to each other, has an array of functions which is now discussed. A possible configuration of section 60 is shown in FIG. 4. The lead-in 46 is shown in this figure being covered by a first unit 70 (a bend restriction unit) that has the function of limiting a bending of the cables (e.g., optical fiber) that are contained inside the lead-in 46. The first unit 70 may also include a clamp (not shown) that is connected to the spread ropes 48. A second unit 72 may also have a bend restriction function and may have another clamp (not shown) that is connected to rope 62 and float 64.

Further units 74, 76, 78, and 80 are connected in series between the second unit 72 and the streamer 12. These units have various roles. One of them is a horizontal damper, another one is a radial damper, another one is a power unit, another one is a control unit, etc. Each of these units is built as an individual unit that can be disconnected from the adjacent units. Currently, when a streamer is to be deployed from a spool into the water, these individual units are on the deck of the vessel unconnected to the streamer. Thus, these individual units need to be attached between the lead-in and the streamer before the streamer is deployed. Reversely, when the streamer is retrieved on the vessel, these units need to be removed prior to wounding-up the streamer on the spool. These operations are time consuming, thus slowing the entire seismic survey, which is undesirable.

Thus, there is a need to provide a simpler device and method for connecting the streamer to the lead-in and also for making the lead-in, streamer and the connecting part capable of being wound on a spool.

### SUMMARY

According to one exemplary embodiment, there is a connecting part configured to connect a lead-in to a streamer. The connecting part includes a single body extending along a longitudinal axis between the lead-in and the streamer; the single body has a first end configured to connect to the lead-in through a first connection device and the body also has a second end configured to connect to the streamer through a second connection device; at least a link connecting the first end to the second end and configured to receive a tension that appears in the single body; a cable extending through the single body and configured to provide data communications; and plural modules provided on the single body. The single body is configured to wound-up on a spool.

According to another exemplary embodiment, there is an acquisition system for recording seismic data while being towed underwater. The acquisition system includes a lead-in configured to be attached with one end to a vessel; a connecting part attached to the other end of the lead-in through a first connection device; and a streamer attached to the connecting part through a second connection device. The connecting part has a single body that is configured to wound-up on a spool.

According to still another exemplary embodiment, there is a connecting part configured to connect a lead-in to a radial damping unit of a streamer. The connecting part includes a single body extending along a longitudinal axis (X) between the lead-in and the radial damping unit; the single body has a first end configured to connect to the lead-in through a first connection device and the body also has a second end configured to connect to the radial damping unit through a second connection device; at least a link connecting the first end to the second end and configured to receive a tension that appears in the single body; a cable extending through the single body and configured to provide data communications; a horizontal damping unit configured to damp horizontal oscillations in the body; brackets for connecting spread ropes; a first electronic board configured to provide control management of seismic channels that come from the streamer; a second electronic board configured to provide data routing; a third electronic board configured to provide data filtering and data compression; and a fourth electronic board configured to digitize the analog data received from the streamers prior to transferring it to the vessel.

According to still another exemplary embodiment, there is a method of manufacturing a connecting part for connecting a lead-in to a streamer. The method includes providing a single body extending along a longitudinal axis (X) between the lead-in and the streamer; attaching a first connecting device to the single body at a first end, the first connecting device being configured to connect to the lead-in; attaching a second connecting device to the single body at a second end, the second connecting device being configured to connect to the streamer; embedding into the body at least a link connecting the first end to the second end, the link being configured to receive a tension that appears in the single body; embedding into the body a cable to extend through the single body and configured to provide data communications; and providing on the body plural modules such that the single body is configured to wound-up on a spool.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a data acquisition system;

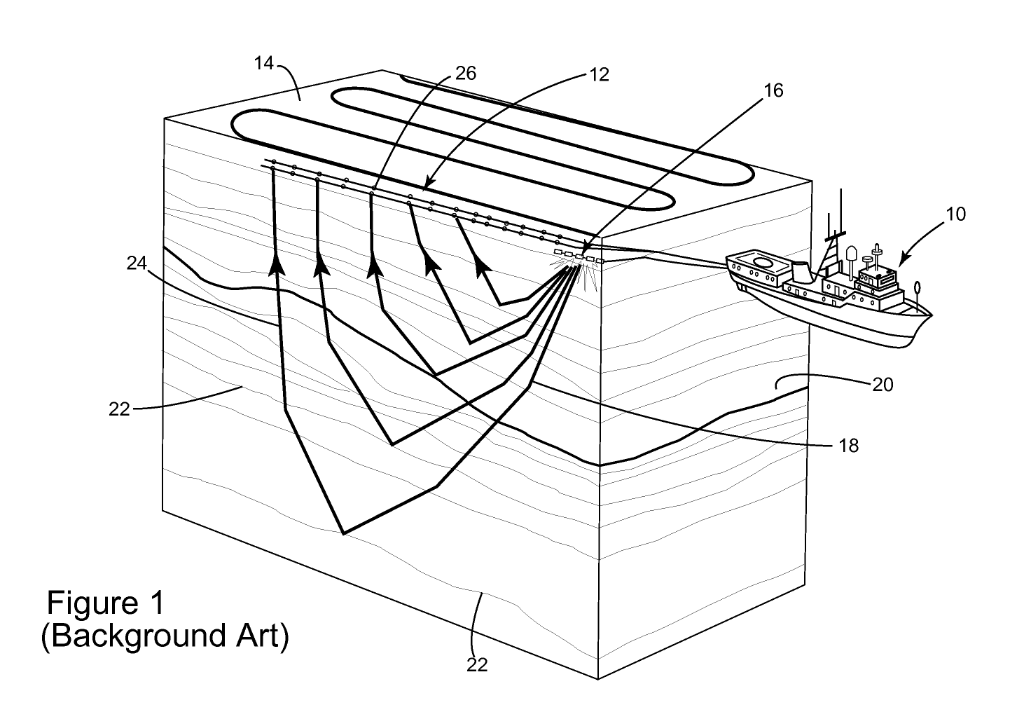

FIG. 2 is a schematic diagram of a front-end gear;

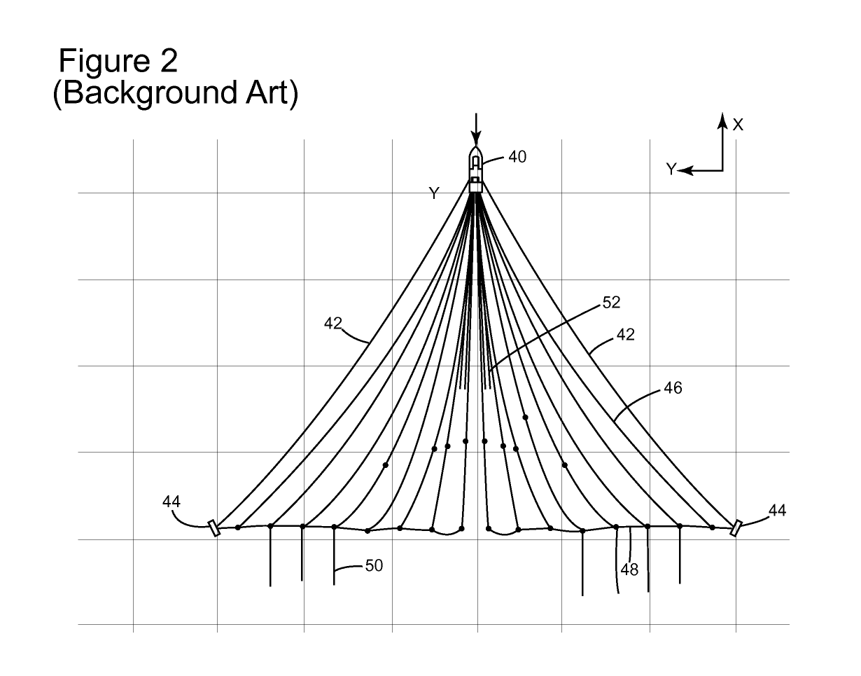

FIG. 3 is a schematic diagram of a connection between a lead-in and a streamer when towed underwater;

FIG. 4 is a schematic diagram of various parts that are provided between a streamer and a lead-in;

FIG. 5 is a schematic diagram of a connecting part according to an exemplary embodiment;

FIG. 6 is a schematic diagram showing various parts of a connecting part according to an exemplary embodiment;

FIG. 7 is a schematic diagram of a horizontal damping unit;

FIG. 8 is a schematic diagram of a connecting part that connects between a lead-in and a radial damping unit according to an exemplary embodiment;

FIG. 9 is a schematic diagram of an external profile of a connecting part according to an exemplary embodiment; and

FIG. 10 is a flow chart of a method for manufacturing a connecting part according to an exemplary embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a method and a connecting part for connecting a lead-in to a streamer such that the entire connecting part can be wound-up on a spool. However, the embodiments to be discussed next are not limited to a marine streamer but may be applied to other structures that need to be wound-up on a spool.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an exemplary embodiment, there is a connecting part having a first end that connects to a lead-in and with a second end to a streamer. The connecting part is made to include various functions that are traditionally performed by multiple modules connected in series between the lead-in and the streamer. For example, the connecting part may include a horizontal damping component, an axial damping component, connections to spread ropes, a connection to a buoy/float, etc.

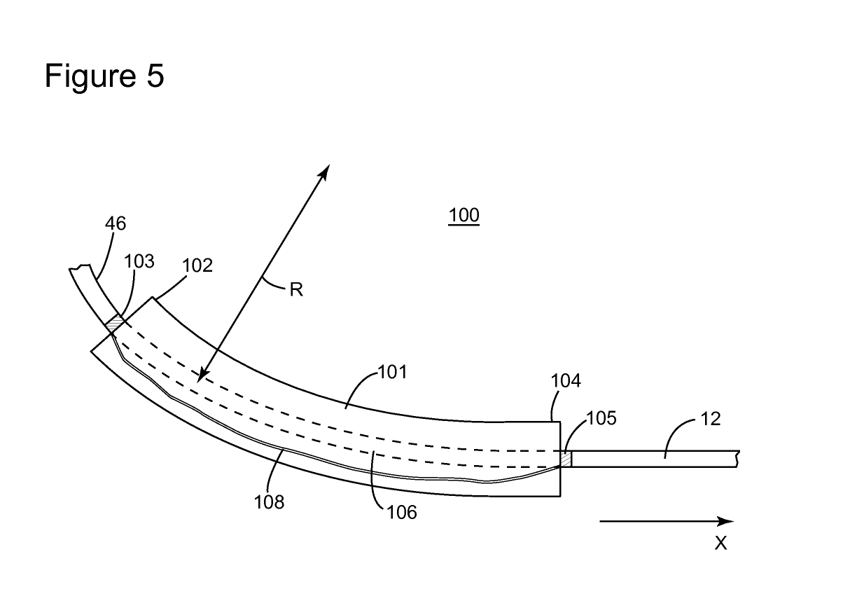

In this respect, FIG. 5 shows the connecting part 100 having a body 101 that partially extends along a longitudinal axis X. The body 101 has a first end 102 connected through a first connection 103 to the lead-in 46 and a second end 104 connected through a second connection 105 to the streamer 12. The connecting part 100 is configured to prevent a bending curve R to be smaller than a certain threshold, e.g., 1.2 m. Other values for the bending curve R are possible depending on the size of the spool on which the connecting part needs to be wound-up. In one application, only portions of the connecting part 100 have this bend restricting function.

The connecting part 100 may be made of a polymer, plastic, or other flexible materials that also exhibit a resistance to bending. A wall of the connecting part 100 may be enforced with a resistant material, for example, wires, ropes, etc. Further, as a large tension is applied to the connecting part 100 by the streamer 12 when towed, a link (e.g., rope or wire or cable) 106 may be provided inside the connecting part for receiving most of the tension. For example, the link may be a rope that connects the first end 103 to the second end 105. The electrical and/or optical cables 108 that connect the streamer 12 to the vessel may be provided along the link 106, inside the body 101.

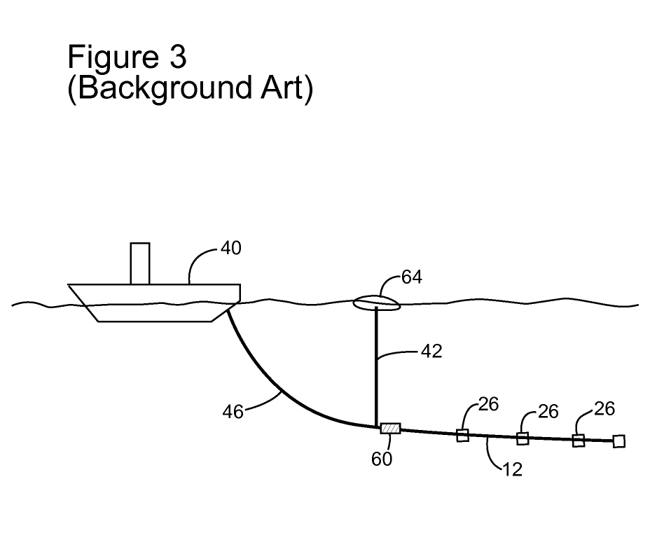

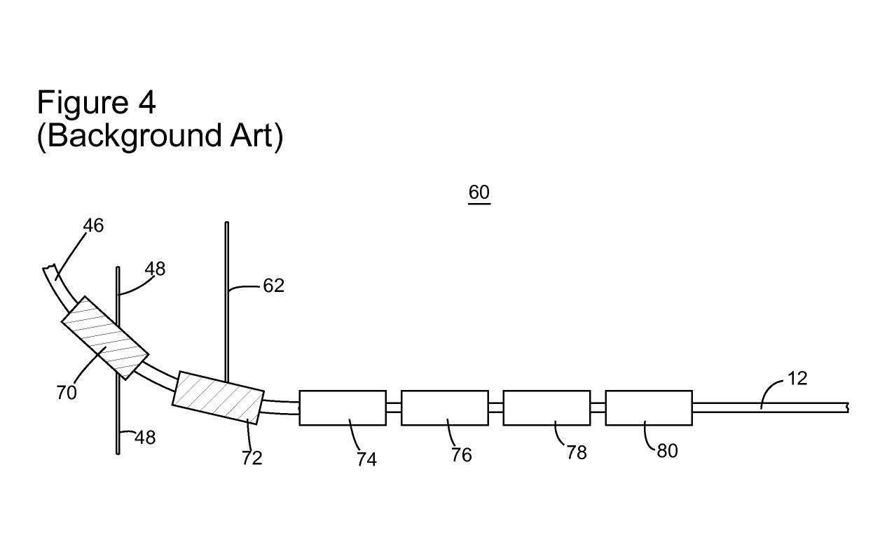

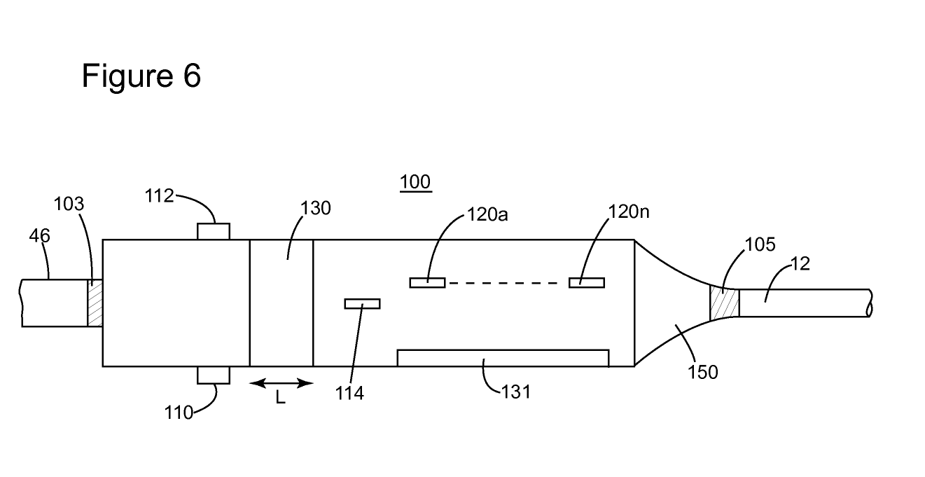

Two brackets 110 and 112 may be attached to the connecting part 100 as shown in FIG. 6, which is a top view. These brackets may be used to connect corresponding spread ropes from adjacent streamers. As further shown in FIG. 6, a bracket 114 may also be connected to the connecting part 100 for providing a connection point to rope 62 (shown in FIGS. 3 and 4) and implicitly to a corresponding float.

The functions of the units 74, 76, 78, and 80 of FIG. 4 may be implemented directly into the connecting part 100. For example, the electronic parts of these units may be directly provided inside the body 101 of the connecting part 100, as shown by reference numbers 120a to 120n, where n depends on how many different electronic boards are needed. For example, one electronic board 120a is configured to provide power to the float 64, another electronic board 120b is configured to provide control management of seismic channels that come from the receivers of the streamer 12, another electronic board 120c is configured to provide frame control, another electronic board 120d is configured to provide data routing, another electronic board 120e is configured to provide data filtering and data compression, another electronic board 120f is configured to digitize the analog data received from the streamer prior to transferring it to the vessel, another electronic board 120g is configured to determine a tensile stress in the connecting part or streamer, etc.

A horizontal damping function may be implemented in a dedicated part 130 of the connecting part 100. For example, this horizontal damping part 130 may be more elastic and damped, for example, with a material having visco-elastic properties than the remaining part of the connecting part 100 so that the horizontal damping part 130 may change its length L to damp the horizontal oscillations that might appear in the connecting part.

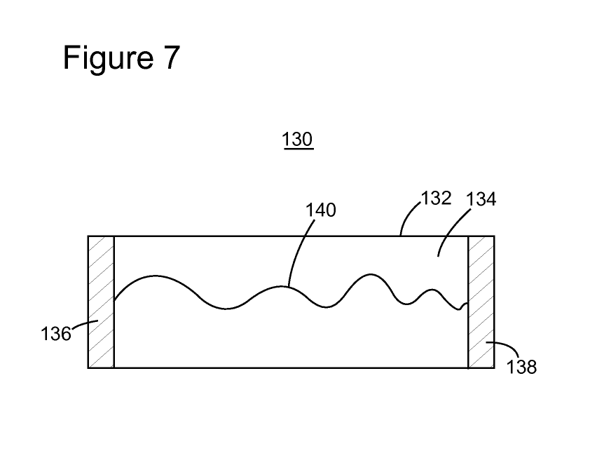

Schematically, a horizontal damping part 130 is illustrated in FIG. 7. The horizontal damping part 130 includes an enclosure 132 in which a damping medium 134 is provided. An oscillation applied to an end 136 of the horizontal damping part 130 is slowed down by the damping medium 134 so that the propagating oscillation is attenuated when arriving at the other end 138. A safety cord 140 may be provided inside the enclosure 132 to prevent the horizontal damping part 130 to overstretch, e.g., past a threshold length. Other mechanisms or methods may be used to damp the horizontal oscillations as would be recognized by those skilled in the art. However, irrespective of which mechanism is used, a common feature of these mechanisms is the inclusion of the horizontal damping mechanism into the connecting part 100. A similar situation happens for the radial damping part 150 which is schematically illustrated in FIG. 6.

FIG. 6 also shows a buoyancy regulation system 131 that is embedded into the connecting part 100. Such a system 131 is configured to control a depth of the head of the streamer 12 by using a variable volume system working by oil transfer or gas decompression. Such systems are known in the art and thus the details of system 131 are not further discussed here. However, the system 131 is made to deflate so that it can be rounded on the spool together with the connecting part 100.

According to another exemplary embodiment, the structure of the connecting part 100 may be arranged in such a way that it is possible that the connecting part has a zero buoyancy, i.e., it is able to float by itself. According to this exemplary embodiment, the need for a float is suppressed and thus the bracket 114 may become unnecessary.

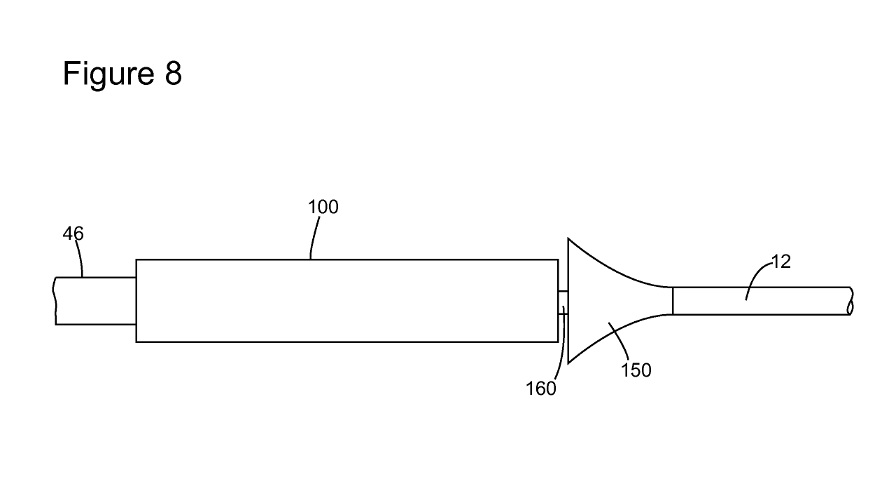

According to still another exemplary embodiment, it is possible to incorporate all the above functions into the connecting part 100 except for the radial damping part 150. Such an embodiment is illustrated in FIG. 8. This figure shows the connecting part 100 having a connection 160 to the radial damping part 150.

According to this exemplary embodiment, the radial damping part 150 is too large to be wound-up on the spool on which the streamer is provided. Thus, the radial damping part 150 in this embodiment is removed prior to wounding-up the streamer 12 on its spool. Such an embodiment is more advantageous comparative to the traditional way of removing plural modules as the time for removing one module (the radial damping part 150) comparative to the time for removing many modules is greatly reduced.

As one of ordinary skilled in the art will recognize, a length of the connecting part 100 varies as a function of the type of streamer used, the front-end gear, the functionalities embedded into the connecting part 100, etc. As an illustrative example, the connecting part 100 may have a length in the order of 200 m, for example, between 150 m and 250 m. Of course, smaller or larger lengths are also possible.

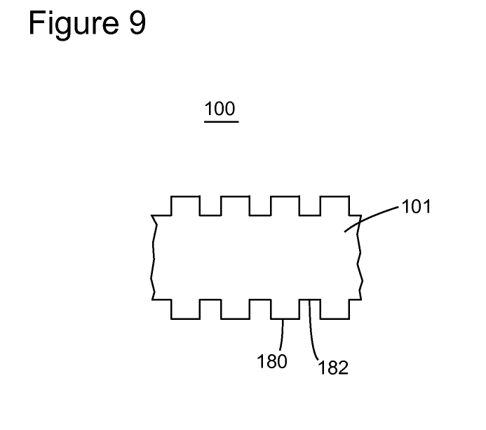

In order to provide resistance to bending, i.e., to limit a bending radius of the connecting part 100, a surface of the body 101 may have a profile as shown in FIG. 9. Thus, the body 101 is designed to have top surfaces 180 and bottom surfaces 182. A bending of the body 101 is limited by a distance between consecutive top surfaces and by a distance between the top and bottom surfaces. Other mechanisms may be used for providing the bend restriction function, as for example, selecting the material from which the connecting part is made to have some flexibility but also high resistance to bending.

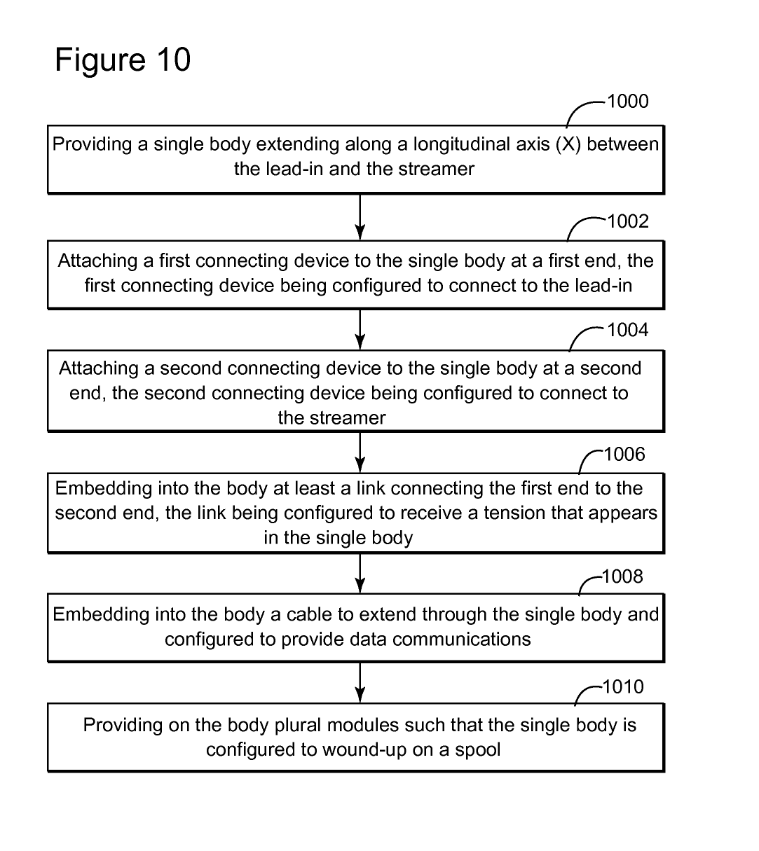

According to an exemplary embodiment illustrated in FIG. 10, there is a method of manufacturing a connecting part (100) for connecting a lead-in (46) to a streamer (12). The method includes a step 1000 of providing a single body (101) extending along a longitudinal axis (X) between the lead-in (46) and the streamer (12); a step 1002 of attaching a first connecting device (103) to the single body (101) at a first end (102), the first connecting device (103) being configured to connect to the lead-in (46); a step 1004 of attaching a second connecting device (105) to the single body (101) at a second end (104), the second connecting device (105) being configured to connect to the streamer (12); a step 1006 of embedding into the body (101) at least a link (106) connecting the first end (102) to the second end (104), the link (106) being configured to receive a tension that appears in the single body (101); a step 1008 of embedding into the body (101) a cable (108) to extend through the single body (101) and configured to provide data communications; and a step 1010 of providing on the body (101) plural modules (130, 120a to 120n, 110, 112, 114, 150) such that the single body (101) is configured to wound-up on a spool.

The above discussed exemplary embodiments advantageously provide a connecting part that can be wound-up on a spool without the need to remove various components and also provide a bend restriction capability.

The disclosed exemplary embodiments provide a connecting part, data acquisition system, and method for connecting a streamer to a lead-in. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A connecting part configured to connect a lead-in to a streamer, the connecting part comprising:
a single body extending along a longitudinal axis (X) between the lead-in and the streamer;
the single body has a first end configured to connect to the lead-in through a first connection device and the body also has a second end configured to connect to the streamer through a second connection device;
at least a link connecting the first end to the second end and configured to receive a tension that appears in the single body;
a cable extending through the single body and configured to provide data communications; and
plural modules provided on the single body,
wherein the single body is configured to wound-up on a spool.

2. The connecting part of claim 1, wherein the plural modules include one or more of a horizontal damping unit, brackets, a radial damping unit, a first electronic board configured to provide power to a float, a second electronic board configured to provide control management of seismic channels that come from the streamer, a third electronic board configured to provide frame control, a fourth electronic board configured to provide data routing, a fifth electronic board configured to provide data filtering and data compression, a sixth electronic board configured to digitize the analog data received from the streamers prior to transferring it to the vessel, a seventh electronic board configured to determine a tensile stress on the connecting part, and a buoyancy regulation system.

3. The connecting part of claim 1, wherein the plural modules include a horizontal damping unit, brackets, a radial damping unit, a first electronic board configured to provide power to a float, a second electronic board configured to provide control management of seismic channels that come from the streamer, a third electronic board configured to provide frame control, a fourth electronic board configured to provide data routing, a fifth electronic board configured to provide data filtering and data compression, a sixth electronic board configured to digitize the analog data received from the streamers prior to transferring it to the vessel, and a seventh electronic board configured to determine a tensile stress on the connecting part.

4. The connecting part of claim 1, wherein the plural modules include a horizontal damping unit, brackets, a radial damping unit, an electronic board configured to provide control management of seismic channels that come from the streamer, an electronic board configured to provide data routing, an electronic board configured to provide data filtering and data compression, an electronic board configured to digitize the analog data received from the streamers prior to transferring it to the vessel, and an electronic board configured to determine a tensile stress on the connecting part.

5. The connecting part of claim 1, wherein the plural modules include a horizontal damping unit, brackets, an electronic board configured to provide control management of seismic channels that come from the streamer, an electronic board configured to provide data routing, an electronic board configured to provide data filtering and data compression, and an electronic board configured to digitize the analog data received from the streamers prior to transferring it to the vessel.

6. The connecting part of claim 1, further comprising:
a bracket connected to the body;
a float configured to maintain the connecting part at a desired depth while being towed underwater; and
a rope configured to connect the bracket to the float.

7. The connecting part of claim 1, wherein the body is configured to restrict a bending of the connecting part to a desired bending radius.

8. The connecting part of claim 1, wherein a length of the body is substantially between 150 and 250 m.

9. The connecting part of claim 1, further comprising:
a horizontal damping part embedded into the body and configured to change its length (L) for damping horizontal oscillations that appear in the body.

10. An acquisition system for recording seismic data while being towed underwater, the acquisition system comprising:
a lead-in configured to be attached with one end to a vessel;
a connecting part attached to the other end of the lead-in through a first connection device;
a streamer attached to the connecting part through a second connection device,
wherein the connecting part has a single body that is configured to wound-up on a spool.

11. The acquisition system of claim 10, wherein the body further comprises:
at least a link connecting a first end to a second end and configured to receive a tension that appears in the single body;
a cable extending through the single body and configured to provide data communications; and
plural modules provided on the single body.

12. The acquisition system of claim 10, wherein the plural modules include one or more of a horizontal damping unit, brackets, a radial damping unit, a first electronic board configured to provide power to a float, a second electronic board configured to provide control management of seismic channels that come from the streamer, a third electronic board configured to provide frame control, a fourth electronic board configured to provide data routing, a fifth electronic board configured to provide data filtering and data compression, a sixth electronic board configured to digitize the analog data received from the streamers prior to transferring it to the vessel, a seventh electronic board onfigured to determine a tensile stress on the connecting part, and a buoyancy regulation system.

13. The acquisition system of claim 10, wherein the plural modules include a horizontal damping unit, brackets, a radial damping unit, a first electronic board configured to provide power to a float, a second electronic board configured to provide control management of seismic channels that come from the streamer, a third electronic board configured to provide frame control, a fourth electronic board configured to provide data routing, a fifth electronic board configured to provide data filtering and data compression, a sixth electronic board configured to digitize the analog data received from the streamers prior to transferring it to the vessel, and a seventh electronic board configured to determine a tensile stress on the connecting part.

14. The acquisition system of claim 10, wherein the plural modules include a horizontal damping unit, brackets, a radial damping unit, an electronic board configured to provide control management of seismic channels that come from the streamer, an electronic board configured to provide data routing, an electronic board configured to provide data filtering and data compression, an electronic board configured to digitize the analog data received from the streamers prior to transferring it to the vessel, and an electronic board configured to determine a tensile stress on the connecting part.

15. The acquisition system of claim 10, wherein the plural modules include a horizontal damping unit, brackets, an electronic board configured to provide control management of seismic channels that come from the streamer, an electronic board configured to provide data routing, an electronic board configured to provide data filtering and data compression, and an electronic board configured to digitize the analog data received from the streamers prior to transferring it to the vessel.

16. The acquisition system of claim 10, further comprising:
a bracket connected to the body;
a float configured to maintain the connecting part at a desired depth while being towed underwater; and
a rope configured to connect the bracket to the float.

17. The acquisition system of claim 10, wherein the body is configured to restrict a bending of the connecting part to a desired bending radius.

18. The acquisition system of claim 10, wherein a length of the body is substantially between 150 and 250 m.

19. The acquisition system of claim 10, further comprising:
a horizontal damping part embedded into the body and configured to change its length (L) for damping horizontal oscillations that appear in the body.

20. A connecting part configured to connect a lead-in to a radial damping unit of a streamer, the connecting part comprising:
a single body extending along a longitudinal axis (X) between the lead-in and the radial damping unit;
the single body has a first end configured to connect to the lead-in through a first connection device and the body also has a second end configured to connect to the radial damping unit through a second connection device;
at least a link connecting the first end to the second end and configured to receive a tension that appears in the single body;
a cable extending through the single body and configured to provide data communications;
a horizontal damping unit configured to damp horizontal oscillations in the body;
brackets for connecting spread ropes;
a first electronic board configured to provide control management of seismic channels that come from the streamer;
a second electronic board configured to provide data routing;
a third electronic board configured to provide data filtering and data compression; and
a fourth electronic board configured to digitize the analog data received from the streamers prior to transferring it to the vessel.

21. A method of manufacturing a connecting part for connecting a lead-in to a streamer, the method comprising:
providing a single body extending along a longitudinal axis (X) between the lead-in and the streamer;
attaching a first connecting device to the single body at a first end, the first connecting device being configured to connect to the lead-in;
attaching a second connecting device to the single body at a second end, the second connecting device being configured to connect to the streamer;
embedding into the body at least a link connecting the first end to the second end, the link being configured to receive a tension that appears in the single body;
embedding into the body a cable to extend through the single body and configured to provide data communications; and
providing on the body plural modules, such that the single body is configured to wound-up on a spool.
